(19) United States
(12) Patent Application Publication
(10) Pub. No.: US 2008/0082457 A1
(43) Pub. Date: Apr. 3, 2008

(54) Methods and Apparatus for Offering and Managing Investment Funds Including Loss Protection Features

(76) Inventor: Joshua C. Adam, Great Neck, NY (US)

Correspondence Address: PRIEST & GOLDSTEIN PLLC, 5015 SOUTHPARK DRIVE, SUITE 230, DURHAM, NC, 27713-7736, US

(21) Appl. No.: 11/536,020

(22) Filed: Sep. 28, 2006

(51) Int. Cl. G06Q 40/00

(52) U.S. Cl. 705/36 R

(57) ABSTRACT

Systems and techniques for organizing and managing investment funds. An investment fund is organized according to an agreement between a managing entity and a plurality of investors, with provisions for compensation for investor losses occurring due to declines in investment value. The risk associated with the obligation for compensation is borne by the managing entity, and the agreement prescribes management fees in an amount calculated to compensate the managing entity for this additional risk. When an event occurs triggering a compensation obligation, the managing entity contributes the required sum, suitably drawn from a previously established compensation fund sufficient to cover the maximum possible obligation.

### FIELD OF THE INVENTION

The present invention relates generally to improved methods and systems for providing financial management services. More specifically, the invention relates to advantageous systems and techniques for designing, marketing, and managing an investment fund, such as a hedge fund, a mutual fund, or the like that provides loss protection to shareholders and better aligns the interests of shareholders and fund managers.

### BACKGROUND OF THE INVENTION

Numerous investment vehicles are available to investors, with most having both the potential for returns and the risk of loss. One popular investment vehicle is a managed investment fund, with investors depositing money to be managed by a third party for a fee. By pooling the assets of multiple investors, an investment company can give investors access to a wider range of securities than the investors themselves would individually have typically been able to access. Also, the investment company is able to gain economies of scale in operation and to negotiate reduced trading costs. One exemplary investment fund is a hedge fund, formed by agreement between a general partner and a plurality of limited partners. A hedge fund is a private investment limited partnership fund that is typically not required to register under securities laws and is free from many securities regulations, such as liquidity requirements and restrictions on the types of investment vehicles that may be purchased. As one example, corporate institutions, high net worth individuals and private partnerships may invest in derivatives, go short, use leverage, or complex combinations of such vehicles to attempt to manage risk while achieving a particular investment goal.

The general partner of a hedge fund charges fees to the limited partners, with the fees often being directly related to the investment returns generated by the fund. One common fee arrangement is that the general partner receives fees of 20% of the investment return of the fund. Other types of funds often charge fees that are related to, or influenced by, the investment returns produced by the fund. For example, a fund might charge a fee of 0.5% of the sum tinder management. This does not explicitly compensate the entity managing the fund based on the performance of the fund, but a high performing fund will tend to attract more capital, so that the fees collected will often tend to increase with fund performance.

When a fund performs poorly, or incurs losses, the investors suffer the losses. The manager's fee may decrease, but the typical third party manager does not share the losses of the fund. As a result, the typical structure of fund management fees tends to create a divergence of interests between managers and investors. Investors are motivated to seek returns and avoid losses, but the typical structure of management fees tends to create a much stronger incentive to pursue high returns than to avoid losses.

### SUMMARY OF THE INVENTION

Among its several aspects, the present invention recognizes that there exists a need for systems and techniques for creating and structuring investment funds and compensation for managers managing the funds that will create a closer commonality of interest between investors and managing entities. Further, there may be investors willing to forego upside return for increased protection against downside risk. According to one aspect, the present invention addresses systems and techniques for compensating investors for losses, along with an investment fee structure calculated to compensate a fund manager or an entity managing a fund for sharing the risk of loss. Thus, in accordance with one aspect of the invention, a fund may compensate investors for losses up to a prescribed limit, preferably by establishing a reserve fund contributed by the fund manager or managing entity based on the amount invested. The management fee structure is set based so as to provide the manager or managing entity with a higher compensation as a result of the reduced risk faced by investors as a result of the loss compensation feature. For example, the management fee may be 50% of an investors return. If an investor withdraws capital while showing a loss, an appropriate sum is allocated to the investor from a reserve fund, based on the investor losses and the compensation limit.

A more complete understanding of the present invention, as well as further features and advantages of the invention, will be apparent from the following Detailed Description and the accompanying drawings.

### BRIEF DESCRIPTION OF THE DRAWINGS

FIG. 1 illustrates an investment fund structure according to an aspect of the present invention;

FIG. 2 illustrates a data processing system for managing an investment fund according to an aspect of the present invention; and

FIG. 3 illustrates a process of investment fund creation, marketing, and management according to an aspect of the present invention.

### DETAILED DESCRIPTION

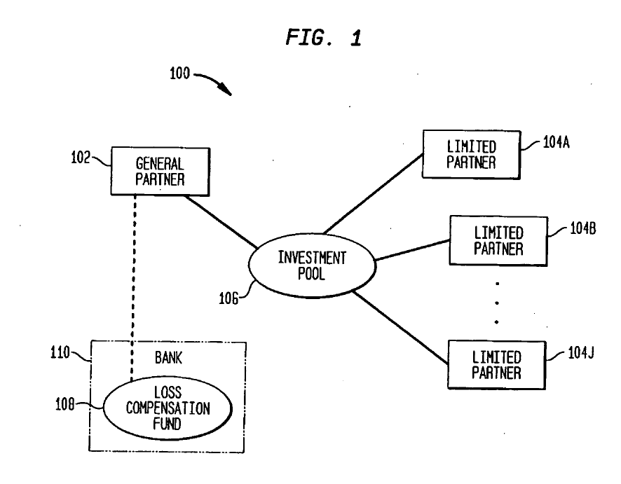

FIG. 1 illustrates an investment fund structure 100 according to an aspect of the present invention. For the sake of illustration, the fund 100 is a hedge fund based on a contractual agreement between a general partner 102 and a plurality of limited partners 104A-104J. The fund 100 includes an investment pool 106, contributed primarily by the limited partners 104A-104J and used to make various investments. The investment pool 102 is under the control of the general partner 102. The general partner 102 makes investments and manages the operations of the fund 100.

In addition to the investment pool 106, the fund 100 also includes an additional loss compensation reserve 108, which is contributed by the general partner 102 out of the funds of the general partner 102. The loss compensation reserve 108 may suitably be based on the total funds invested. The loss compensation reserve 108 may be held by a bank 110, or some other trusted intermediary or fiduciary, and the terms under which the reserve 108 is held may include restrictions on withdrawals commensurate with providing assurance that the reserve 108 will be administered to compensate for losses as agreed.

The operation of the fund 100 is typically governed by an agreement between the general partner 102 and the limited partners 104A-104J, with the agreement suitably providing for the mechanics of investment and redemption, time that an investment must remain deposited before redemption is allowed, terms of compensation for the general partner 102, details of loss compensation for the limited partners 104A-104J, and other necessary details for management of the fund 100.

In the present example, the manager's compensation is based on the positive return generated by the fund 100, for example, 50%, and the loss compensation for a limited partner is 10% of the investment of the limited partner. General partners in traditional hedge funds charge a fee of 20% of the fund's return, and the larger fee of the fund 100 reflects the greater risk borne by the general partner.

In a typical scenario, the general partner 102 will solicit investors, presenting information relating to characteristics and desired investment goals of the fund 100, and will, before or after such solicitations, provide necessary infrastructure and personnel in order to operate the fund. The costs of any infrastructure and personnel, such as office space, trading computers, salaries of support staff, researchers and traders, for example, will typically be investments made by the general partner, with the investment pool 106 contributed by the limited partners being reserved for investments to be made by the fund 100. Once the limited partners 104A-104J have agreed to participate in the fund 100 and have provided capital, the fund 100 begins its investment operations. If the fund 100 is so structured, additional investors may be allowed to invest in and participate in the fund by becoming additional limited partners.

If a limited partner incurs losses, in accordance with the invention, these losses may be compensated according to a schedule prescribed in the agreement between the general partner 102 and the limited partners 104A-104J. The schedule may prescribe factors such as the length of time the investment must be held in order to be eligible for loss compensation, the conditions under which loss compensation is to be available, and the limits on loss compensation, for example, the 10% of the limited partner's investment referred to above. The conditions under which loss compensation is to be available may include one or more of a number of different conditions. For example, compensation may be available if a limited partner has redeemed all or part of his investment at a loss after holding the investment for the minimum prescribed period. To take another example, compensation may be available if an investor claims compensation after having shown a paper loss on an investment for a prescribed period. In such a case, the agreement between the general partner 102 and the limited partners 104A-104J might prescribe that a subsequent redemption by the investor might be reduced to account for the compensation already received if the value of the limited partner's investment partially or fully recovers. As another example, as an incentive to reduce capital flight from the fund, one level of compensation may be available if funds were withdrawn and a different higher level of compensation may apply if a paper loss lasts a predetermined time, but funds are left invested.

To take an example, suppose that an initial investment pool 106 is funded with $1,000,000, based on investments of $100,000 from each of ten limited partners 104A-104J. The general partner contributes a sum of 10% of the initial investment pool, or $100,000 to the compensation fund 108. After 6 months, the value of the investment pool 106 has declined by 15%, to $85,000, and the proportionate share of each of the limited partners 104A-104J is $85,000. The value of the compensation fund 108 is still $100,000 or slightly above if invested in a relatively risk free vehicle. At this point, if limited partner 104A withdraws his or her investment) he or she will receive $95,000, which is the value of the investment at the time of withdrawal of 106 $85,000, plus compensation up to the agreed limit, which is 10% of the original investment, or $10,000. After a further 6 months, if the value of the investment pool has recovered from $765,000 ($850,000(minus limited partner 104A's withdrawal of $85,000) to $900,000, then the original loss of the remaining limited partners 104A-104J has now been fully recovered. The remaining compensation fund is $90,000) and sufficient to satisfy the maximum possible claims of the nine remaining limited partners. If at this point limited partner 104B withdraws from the fund 100, he or she will receive $100,000 from the investment pool 106, and will not receive any compensation. The general partner 102 may now withdraw $10,000 from the loss compensation fund 108, because $80,000 is now sufficient to satisfy the maximum possible claims of each of the eight remaining limited partners. Alternatively, a new limited partner can now join the fund without requiring additional funds to be added to the loss compensation fund 108.

If after a further 6 months the value of the investment pool stands at $1,000,000, this value now represents a 25% gain for the remaining eight limited partners over their initial investment of $800,000. At this point, if limited partner 104C withdraws from the fund 100, the proportionate gross share of the limited partner 104C is $125,000, but this amount is reduced by $12,500, representing the management fee (50% of the gain of $25,000) owed to the general partner. The value of the investment pool 106 is now $875,000, and the compensation fund 108 can be reduced to $70,000. While not presently preferred, as an alternative, the loss compensation pool can be contractually set up so that no money is withdrawn from it by the general partner so that remaining investors have greater absolute dollar protection, or such greater protections could be offered only if limited partners remain invested for a prescribed period.

Suppose now that a limited partner is able to claim compensation if, for example, the value of his or her investment depreciates by a prescribed amount for a prescribed length of time, such as 25% for two years. Continuing with our example, we assume the value of the investment fund 106 now declines from $875,000 to $525,000, and remains at or below that value for two years. Suppose that all seven of the remaining limited partners then claim compensation, but do not withdraw their investments. The general partner then pays out $70,000 from the compensation fund 108, $10,000 to each of the remaining limited partners, exhausting the fund 108 and satisfying all claims. The compensation fund 108 does not need to be replenished at this point, because the maximum possible claims have been fully satisfied.

Subsequently, suppose that the value of the investment fund 106 increases to $1,400,000, and the limited partner 104D withdraws his or her share. The proportionate gross share of the limited partner 104D is $200,000, of which $100,000 represents investment gains. The limited partner 104D is allowed to withdraw $140,000, because his or her share is reduced by the management fee of 50% of the gains, or $50,000, to the general partner 102, as well as reduced by the $10,000 in compensation already received.

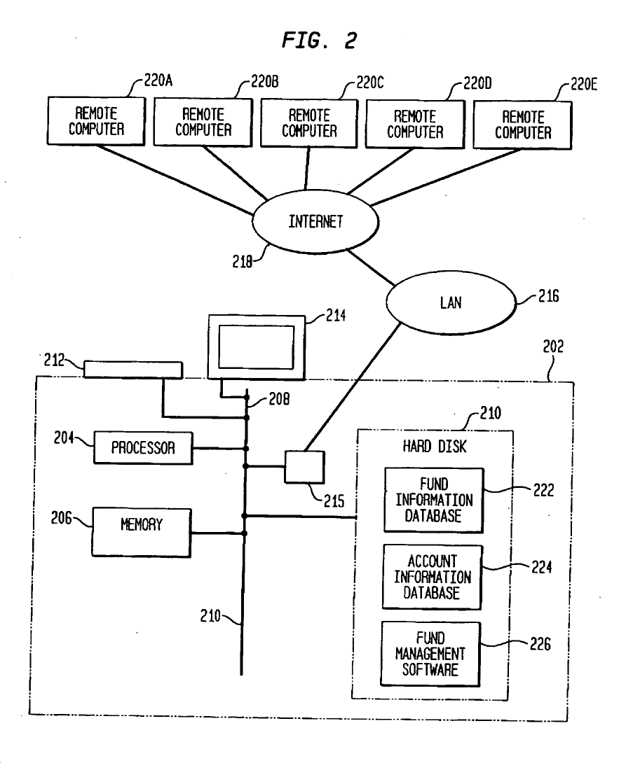

FIG. 2 illustrates a system 200 suitable for use in managing an investment fund such as fund 100 of FIG. 1, according to an aspect of the present invention. The system 200 may suitably include a computer 202. The computer 202 includes a processor 204, high speed memory 206, long term storage such as a hard disk 208, suitably communicating over a bus 210. In addition, the computer 202 may include user interface devices such as a keyboard 21.2 and display 214, and a remote interface 215, for communicating with other computers and devices, for example, through a network 216. The network 216 may allow for public connection through the public Internet 218. Typically, encryption will be employed to secure any investment related data and communications. Such an arrangement allows, for example, easy connection to personal computers of investors or potential investors, for example, the computers 220A-220E.

The suitably programmed central computer 204 may be used to maintain information and perform operations relating to a fund such as the fund 100. For example, the hard disk 210 may store a fund information database 222, maintaining financial and investment information for the fund. The fund information database 222 may include, or may be accompanied by, an account information database 224, providing individualized information for each investor. The central computer 204 may also suitably host fund management software 226, which provides an interface to a managing entity for reviewing data and performing operations for the fund as a whole, as well as individual interfaces for investors, allowing an investor to review his or her information and perform operations relating to his or her investment. For example, an investor may view the amounts deposited and withdrawn, the current value of the investment, whether the investment represents a current profit or loss, and may also view the progress of the investment over time. The investor may also enter orders for deposits and withdrawals and may view the net amount that would be received upon withdrawal, taking into account the loss compensation, if any, that would be received, or the management fees, if any, that would be imposed.

The managing entity may review investments made and their performance, amounts received from and paid to investors, fees earned and received, loss compensation paid and due to investors, and the status of the loss compensation fund, as well as numerous other items of information typical of such funds. The managing entity may also manage the fund's investment portfolio, purchasing and selling investments as needed, may deposit and withdraw funds into and from the loss compensation fund, and may make disbursements to investors, as well as performing other operations useful for management of the fund. Alternatively, the withdrawal of funds from the loss compensation fund may be restricted so that the manager or managing entity can only receive funds based upon the independent analysis of a trusted intermediary or a fiduciary representing the limited partners.

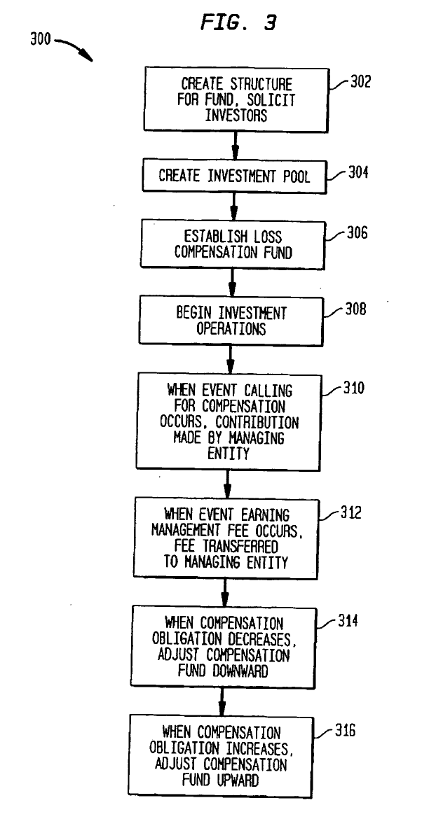

FIG. 3 illustrates a process 300 of fund organization and management according to an aspect of the present invention. At step 302, a structure for an investment fund is created, suitably described in a proposed contractual agreement between a manager or managing entity and a plurality of potential investors. The structure of the fund includes provisions for compensation by the managing entity of an investor suffering a loss due to a decline in value of the fund, with the compensation being subject to prescribed limits and available under specified circumstances. The structure of the fund also may suitably provide for a fee structure calculated to compensate the managing entity for the risk of undertaking the loss compensation obligation. For example, the fee may be based on a percentage of positive investment returns generated by the fund, with the percentage due to the managing entity being greater than for managing entities of similar funds lacking loss compensation provisions. At step 304, when a sufficient number of investors have subscribed to the fund and contributed their investment capital, and investment pool is created for management by the managing entity. At step 306, a loss compensation fund is established through contributions from the managing entity, suitably sufficient to satisfy the maximum possible loss compensation for all investors. At step 308, investment operations are begun. At step 310, when an event occurs calling for compensation, an appropriate contribution is made by the managing entity, suitably by a withdrawal from the compensation fund. At step 312, when a management fee is due to the managing entity, an appropriate transfer is made to the managing entity, for example by deduction from a withdrawal paid to an investor, or a deduction from the investment pool. At step 314, when the loss compensation obligation decreases, for example, when an investor partially or totally withdraws from the fund without loss, the loss compensation fund may be adjusted, suitably through a transfer to the managing entity. At step 316, when the loss compensation obligation increases, for example, through an additional investment by a current or new investor, the loss compensation fund is increased through a contribution by the managing entity.

While the present invention is disclosed in the context of aspects of presently preferred embodiments, it will be recognized that a wide variety of implementations may be employed by persons of ordinary skill in the art consistent with the above discussion and the claims which follow below. For example, the compensation of the manager or managing entity may be the same as or lower than that of a similar entity without loss compensation, with the loss compensation feature being utilized as a selling feature providing a competitive advantage.

I claim:

1. A method of organizing an investment fund, comprising the steps of:
establishing a prospective agreement between a fund manager and a plurality of investors including an obligation on the part of the fund manager to compensate investors for investment losses incurred by the fund under prescribed circumstances and subject to prescribed limits;
establishing an investment pool using deposits from investors;
establishing a compensation fund contributed by the fund manager; and
when an event occurs calling for compensation of an investor, transferring an appropriate contribution from the compensation fund to the investor.

2. The method of claim 1, wherein the agreement organizing the fund includes provisions setting management fees calculated to compensate the managing entity for the additional risk resulting from the compensation obligation.

3. The method of claim 3, wherein the management fee is a portion of the positive returns of the fund and is a higher proportion of the returns of the fund than of fees charged by similar funds without a compensation obligation on the part of the managing entity.

4. The method of claim 2, further comprising a step of transferring an appropriate proportion of the compensation fund to the managing entity when the compensation obligation of the managing entity is reduced without an accompanying depletion of the compensation fund.

5. The method of claim 5, further comprising a step of transferring an appropriate contribution from the managing entity to the compensation fund when the compensation obligation of the managing entity increases.
